(19) United States
(12) Patent Application Publication
(10) Pub. No.: US 2012/0011250 A1
(43) Pub. Date: Jan. 12, 2012

(54) COMMUNICATION PROGRAM, COMMUNICATION METHOD, AND ELECTRIC APPARATUS

(75) Inventors: Morihisa KAWAI, Kawasaki (JP); Ikuo TAKEKAWA, Kawasaki (JP); Teruhiko ONISHI, Kawasaki (JP)

(73) Assignee: FUJITSU LIMITED, Kawasaki (JP)

(21) Appl. No.: 13/168,154

(22) Filed: Jun. 24, 2011

(30) Foreign Application Priority Data
Jul. 7, 2010 (JP) 2010-154783

(51) Int. Cl. G06F 15/16

(52) U.S. Cl. 709/224

(57) ABSTRACT

An apparatus includes an information transmission part that transmits first information including an allocated IP address and a group identifier identifying a group to another apparatus that manages communication by the group, when connecting to the Internet; and a list reception part that receives a list in which IP addresses used for performing intercommunication in the group identified by the group identifier in the first information are listed, as a response to the first information from the computer. A communication part of the apparatus performs communication by using the IP addresses listed in the received list.

### CROSS-REFERENCE TO RELATED APPLICATIONS

This application is based upon and claims the benefit of priority of the prior Japanese Patent Application No. 2010-154783, filed on Jul. 7, 2010, the entire contents of which are incorporated herein by reference.

### FIELD

The embodiments of the invention relate to a technique of managing communication of an electric apparatus.

### BACKGROUND

Electric apparatuses having a function of being connectable to the Internet, such as televisions and hard disk recorders, have been popularized. For example, when the user of an electric apparatus desires to use recording data of a hard disk recorder in a television, the user directly connects the television to the hard disk recorder via a cable or the like. However, when electric apparatuses such as a television and a hard disk recorder are located at positions distant from each other (e.g., the television is on the first floor, and the hard disk recorder is on the second floor), it is difficult to directly connect the electric apparatuses via a cable or the like. In this case, in order to transmit/receive recording data, it is considered that the electric apparatuses are caused to communicate with each other via the Internet by using an IP (Internet Protocol) address allocated to each electric apparatus. An IP address is allocated to each electric apparatus each time each electric apparatus connects to the Internet. Thus, an electric apparatus that communicates with another electric apparatus to which an IP address is allocated does not know the IP address of the other electric apparatus and cannot communicate with the other electric apparatus. Therefore, a technique is known in which the electric apparatus is enabled to communicate with the other electric apparatus to which the IP address is allocated, notifying the electric apparatus of the IP address (e.g., Japanese Unexamined Patent Application Publication No. 2006-33563).

### SUMMARY

According to an aspect of the embodiment, a communication program that manages communications of a plurality of electric apparatuses connectable to the Internet, by a group, the communication program causing a computer to perform a process includes: storing a management table storing a record in which an IP address of each electric apparatus and a group identifier identifying a group to which each electric apparatus belongs are associated with each other; when first information including an IP address and a group identifier is received from an electric apparatus connected to the Internet, updating the management table on the basis of the first information; and referring to the updated management table, generating, from all records each including the group identifier in the first information, a list in which an IP address used for each electric apparatus belonging to a group identified by the group identifier to perform intercommunication in the group is listed, and transmitting the list to each IP address listed in the list.

The object and advantages of the embodiment(s) will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is an overall configuration diagram of a system according to an embodiment.

FIG. 2 is a functional configuration diagram of a server and an electric apparatus.

FIG. 3 is a diagram illustrating a management table.

FIG. 4 is a hardware configuration diagram of the server.

FIG. 5 is a diagram illustrating a group list.

FIG. 6 is a flowchart of authentication with the server when an information transmission part of the electric apparatus obtains an IP address.

FIG. 7 is a flowchart of an apparatus information transmission process.

FIG. 8 is a flowchart of a group management process.

FIG. 9 is a flowchart of an apparatus presence monitoring process.

FIG. 10 is a flowchart of a confirmation message response process.

FIG. 11 is a flowchart of a group list reception process.

FIG. 12 is a flowchart of a request message process.

FIG. 13 is an overall configuration diagram of a system according to another embodiment in which a mobile phone is used instead of the server.

FIG. 14 is a diagram illustrating an allocation notification mail that an electric apparatus A transmits to the mobile phone.

### DETAILED DESCRIPTION OF EMBODIMENT(S)

In the existing art described above, when the other electric apparatus to which the IP address is allocated notifies the electric apparatus of the IP address, if the electric apparatus has been disconnected from the Internet (e.g., the electric apparatus is turned off), the electric apparatus cannot receive the notified IP address. Thus, the electric apparatus does not know the IP address of the other electric apparatus to which the IP address is allocated and cannot communicate with the other electric apparatus to which the IP address is allocated.

Hereinafter, a technique according to embodiments of the invention will be described in detail with reference to the accompanying drawings.

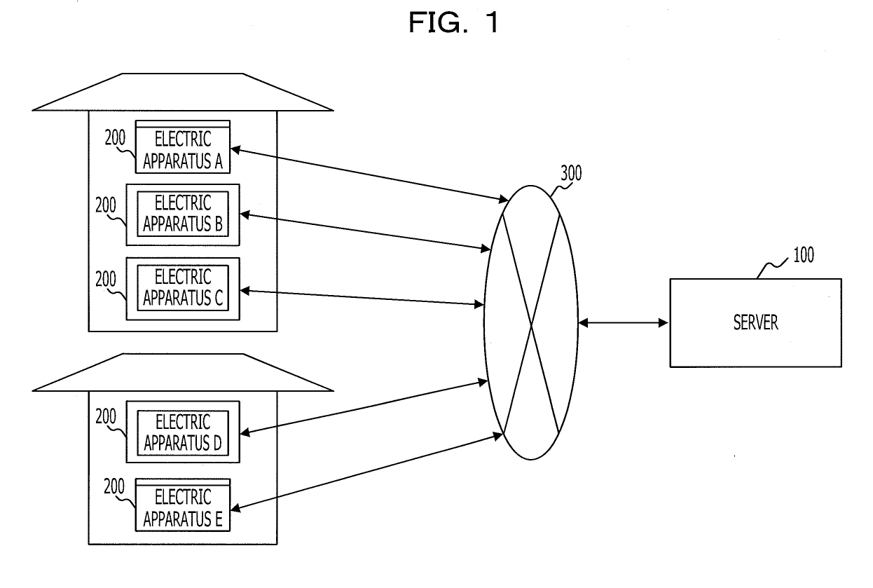

FIG. 1 is an overall configuration diagram of a system according to an embodiment of the technique.

In the system, a server 100 and a plurality of electric apparatuses 200 such as a television and a hard disk recorder are connected to each other via the Internet 300. Each electric apparatus 200 has a function to connect directly to the Internet 300 not via a router or the like.

The plurality of electric apparatuses 200 is divided into two or more groups in each of which electric apparatuses 200 communicate with each other. Each electric apparatus 200 has a communication range (domain) defined by a group to which the electric apparatus 200 belongs. In addition, a group name is assigned to each group, as an example of a group identifier for identifying the group. For example, when an electric apparatus 200 belongs to a group having a group name of α, the communication range of the electric apparatus 200 is all electric apparatuses 200 that belong to the group α. A group name and electric apparatuses 200 that belong to a group are defined by the user of each electric apparatus 200. The defined group name is stored in each electric apparatus 200 by the user of each electric apparatus 200 performing setting in a setting screen or the like. For example, when the user of domestic electric apparatuses 200 desires to use data such as recording data or music data in the domestic electric apparatuses 200, the user defines the domestic electric apparatuses 200 as one group and stores an optional group name in each electric apparatus 200.

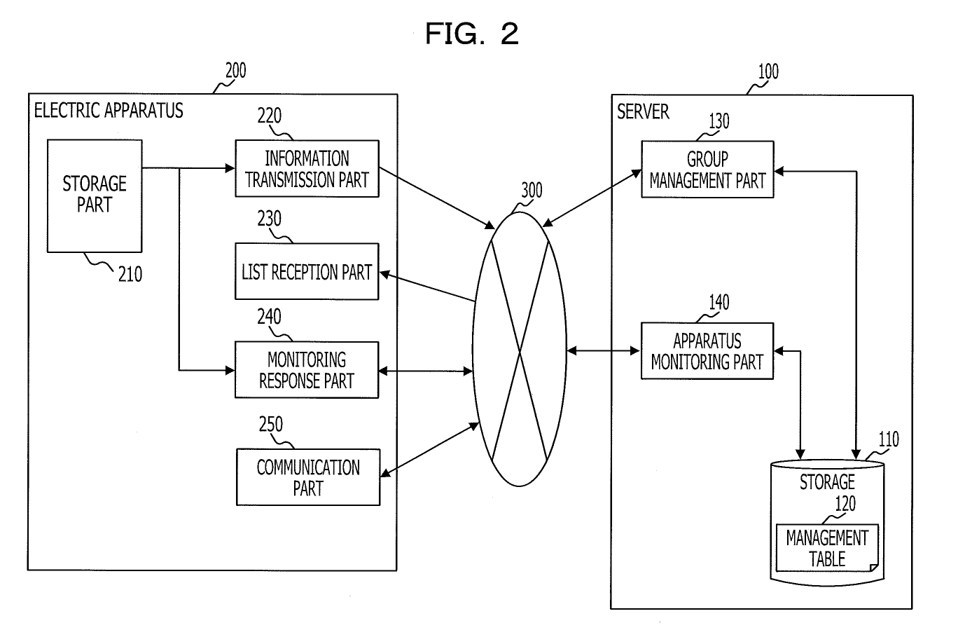

The server 100 includes a storage 110 such as a hard disk drive or an SSD (Solid State Disk) as illustrated in FIG. 2. In the storage 110, a management table 120 is stored.

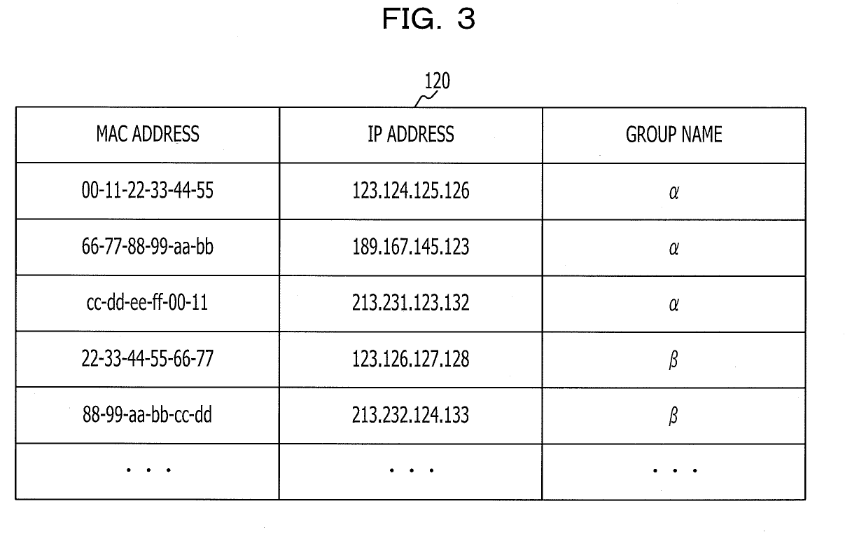

In FIG. 3, in the management table 120, a record in which at least a MAC (Media Access Control) address, an IP address, and a group name of an electric apparatus 200 are associated with each other is stored for each electric apparatus 200.

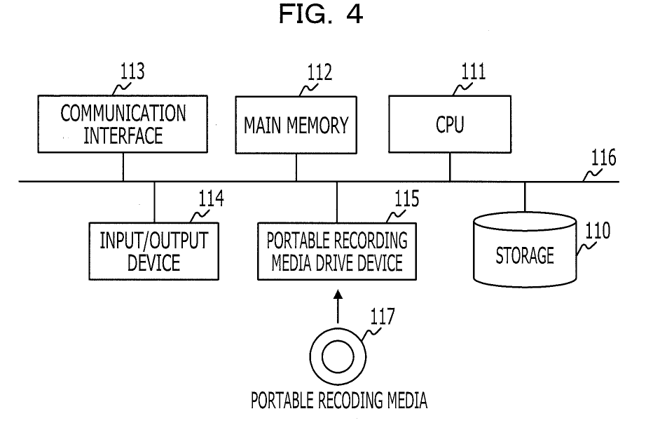

As illustrated in FIG. 4, the server 100 includes hardware such as a CPU (Central Processing Unit) 111, a main memory 112, a communication interface 113, the storage 110, an input/output device 114, and a portable recording media drive device 115. The hardware is connected to each other via a bus 116. The main memory 112 is a storage device that the CPU 111 accesses, and specific examples thereof include a RAM (Random Access Memory). In addition, the communication interface 113 is a device for transmitting/receiving data via a network, and specific examples thereof include a network card. Further, the input/output device 114 is a device for inputting data into the server 100 or outputting data from the server 100, and specific examples thereof include a keyboard, a mouse, and a display. The portable recording media drive device 115 is a device for reading data from a portable recoding media 117 in which computer-readable data is recorded, such as a CD-ROM or a DVD-ROM, and specific examples thereof include a CD-ROM drive and a DVD-ROM drive.

In the portable recoding media 117, a communication program that embodies the embodiment is recorded. The communication program recorded in the portable recoding media 117 is installed in the storage 110 from the portable recording media drive device 115 by known means. The CPU 111 embodies a group management part 130 and an apparatus monitoring part 140 by loading the installed communication program into the main memory 112 and executing the communication program. In addition, the communication program may be installed in the storage 110 from the network through the communication interface 113.

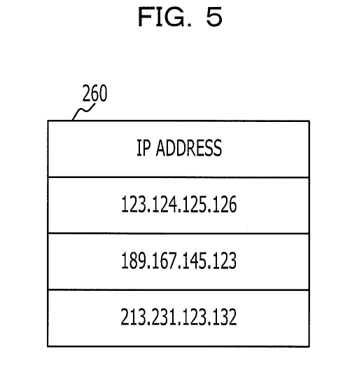

The group management part 130 manages the management table 120 and transmits a group list 260 illustrated in FIG. 5 to each electric apparatus 200. Specifically, in the group list 260, on a group basis, the IP address of each electric apparatus 200, belonging to a specific group, in its record stored in the management table 120 is listed.

The apparatus monitoring part 140 transmits a confirmation message to each electric apparatus 200 at regular intervals and deletes, from the management table 120, the records of electric apparatuses 200 from which no response has been received within a predetermined time period.

Each electric apparatus 200 includes a storage part 210 such as a nonvolatile memory as illustrated in FIG. 2. In the storage part 210, the IP address of the server 100 and the group name of the group to which the own electric apparatus 200 belongs are stored.

Further, each electric apparatus 200 includes an information transmission part 220, a list reception part 230, a monitoring response part 240, and a communication part 250.

The information transmission part 220 transmits, to the server 100, an allocation notification indicating that an IP address is allocated to the own electric apparatus 200, or a disconnection notification indicating that the own electric apparatus 200 is disconnected from the Internet 300.

The list reception part 230 receives the group list 260 transmitted from the server 100 and holds the group list 260 in the own electric apparatus 200.

The monitoring response part 240 receives the confirmation message transmitted from the server 100 and transmits a response message to the server 100.

The communication part 250 transmits a request message describing a content requested of another electric apparatus 200 in the group to which the own electric apparatus 200 belongs. In addition, the communication part 250 processes a request message received from another electric apparatus 200 in the group to which the own electric apparatus 200 belongs.

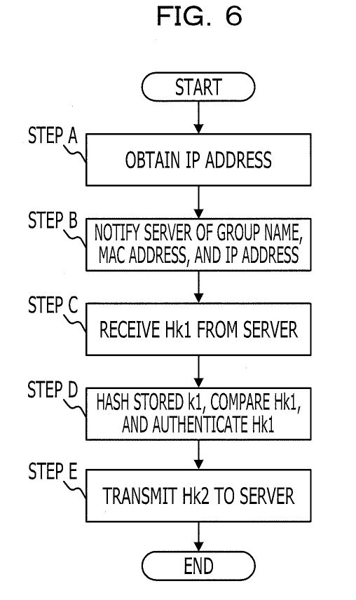

FIG. 6 is a flowchart of authentication with the server 100 when the information transmission part 220 of each electric apparatus 200 obtains an IP address.

The IP address of the server 100 and authentication information k1 and k2 are previously set in each electric apparatus 200, and authentication information k1 and k2 (the same as that set in each electric apparatus 200) is previously set in the server 100.

When each electric apparatus 200 starts up, connects to the Internet 300, and obtains an IP address (operation A), the information transmission part 220 notifies the server 100 of the group name, the MAC address, and the IP address (operation B).

The server 100 having received the notification hashes k1 (hereinafter, Hk1) and transmits Hk1 to the notified IP address.

When the electric apparatus 200 receives Hk1 (operation C), the information transmission part 220 hashes k1 stored in the electric apparatus 200, compares k1 to Hk1, and authenticates Hk1 (operation D), and then hashes k2 (hereinafter, Hk2) and transmits Hk2 to the server 100 (operation E).

The server 100 having received Hk2 hashes k2 stored therein, compares k2 to Hk2, and authenticates Hk2.

The server 100 having authenticated the electric apparatus 200 forms/updates the management table 120 illustrated in FIG. 3, and notifies the electric apparatus 200 of the group list 260.

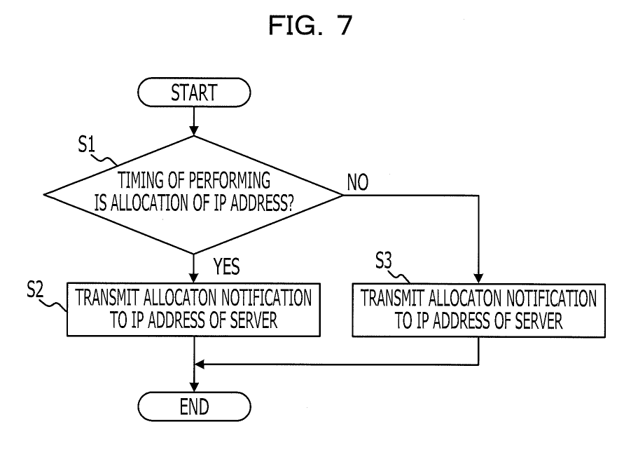

FIG. 7 illustrates a flowchart of an apparatus information transmission process that is performed by the information transmission part 220 of the electric apparatus 200 when an IP address is allocated to the own electric apparatus 200 or a power cutting process is started in the own electric apparatus 200. Examples of the timing when an IP address is allocated to the electric apparatus 200 include the timing when the electric apparatus 200 is newly connected to the Internet 300, and the timing when the electric apparatus 200 is reconnected to the Internet 300. In the following description, an IP address allocated when the electric apparatus 200 is newly connected to the Internet 300 is abbreviated to “new IP address”, and an IP address allocated when the electric apparatus 200 is reconnected to the Internet 300 is abbreviated to “variation IP address”.

At S1, the information transmission part 220 determines whether or not the timing when the apparatus information transmission process is performed is the timing of allocation of an IP address. When it is the timing of allocation of an IP address, the information transmission part 220 advances the processing to S2 (Yes). On the other hand, when it is not the timing of allocation of an IP address, the information transmission part 220 advances the processing to S3 (No).

At S2, the information transmission part 220 transmits an allocation notification including a new IP address or a variation IP address, the MAC address of the own electric apparatus 200, and the group name stored in the storage part 210, to the IP address of the server 100 stored in the storage part 210.

It should be noted that the allocation notification is one example of first information.

At S3, the information transmission part 220 transmits a disconnection notification including the IP address of the own electric apparatus 200, to the IP address of the server 100 stored in the storage part 210.

It should be noted that the disconnection notification is one example of second information.

According to the apparatus information transmission process, when a new IP address or a variation IP address is allocated to the own electric apparatus 200, the information transmission part 220 transmits an allocation notification to the server 100. In addition, when the power cutting process is started in the own electric apparatus 200, the information transmission part 220 transmits a disconnection notification to the server 100.

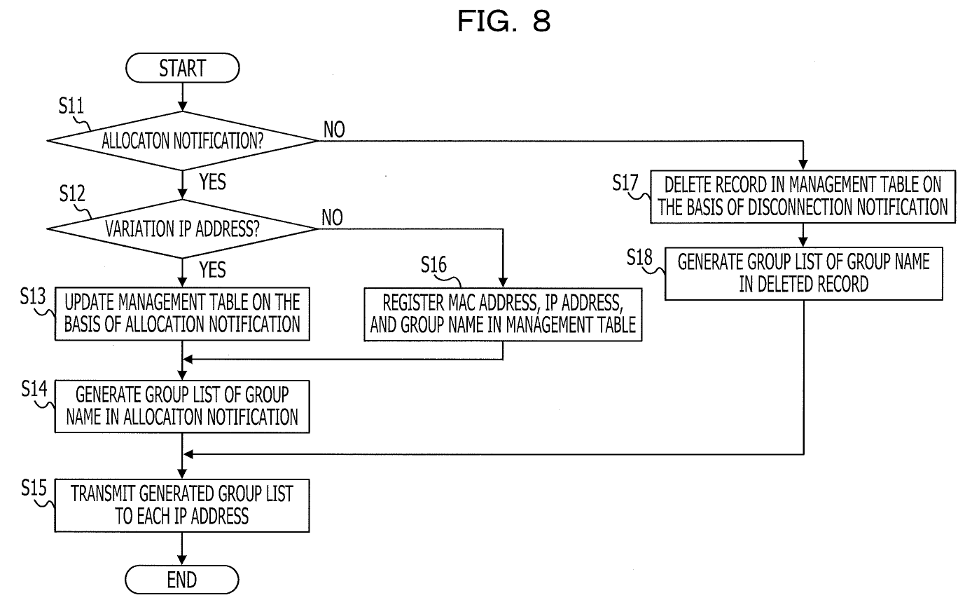

FIG. 8 illustrates a flowchart of a group management process that is performed by the group management part 130 of the server 100 when an allocation notification or a disconnection notification is received from an electric apparatus 200.

At S11, the group management part 130 determines whether or not a received notification is an allocation notification by determining whether or not the received notification includes a MAC address. When the received notification is an allocation notification, the group management part 130 advances the processing to S12 (Yes). On the other hand, when the received notification is not an allocation notification, the group management part 130 advances the processing to S17 (No).

At S12, the group management part 130 determines whether or not the IP address in the allocation notification is a variation IP address by determining whether or not a record identified by the MAC address in the allocation notification is present in the management table 120. When the IP address is a variation IP address, the group management part 130 advances the processing to S13 (Yes). On the other hand, when the IP address is not a variation IP address, the group management part 130 advances the processing to S16 (No).

At S13, the group management part 130 refers to the management table 120 and identifies a record including the MAC address in the allocation notification. In addition, the group management part 130 updates the IP address in the identified record to the IP address in the allocation notification.

At S14, the group management part 130 refers to the management table 120 and identifies all records each including the group name in the allocation notification. In addition, the group management part 130 generates a group list 260 from the IP addresses in all the identified records.

At S15, the group management part 130 transmits the generated group list 260 to each of electric apparatuses 200 identified by the IP addresses listed in the generated group list 260.

At S16, the group management part 130 registers, in the management table 120, a record in which the MAC address, the IP address, and the group name that are included in the allocation notification are associated with each other.

At S17, the group management part 130 refers to the management table 120 and extracts a group name from a record identified by the IP address included in the disconnection notification. In addition, the group management part 130 deletes the identified record from the management table 120.

At S18, the group management part 130 refers to the management table 120 and identifies all records each including the extracted group name. In addition, the group management part 130 generates a group list 260 from the IP addresses in all the identified records, which is then transmitted at S15.

According to the group management process, the group management part 130 updates the management table 120 on the basis of the received allocation notification or disconnection notification. In addition, the group management part 130 refers to the management table 120 and identifies all the records each including the group name of the group to which the electric apparatus 200 that is the transmission source of the allocation notification or disconnection notification belongs. Then, the group management part 130 generates the group list 260 from the IP addresses in all the identified records, and transmits the generated group list 260 to all the IP addresses listed in the generated group list 260.

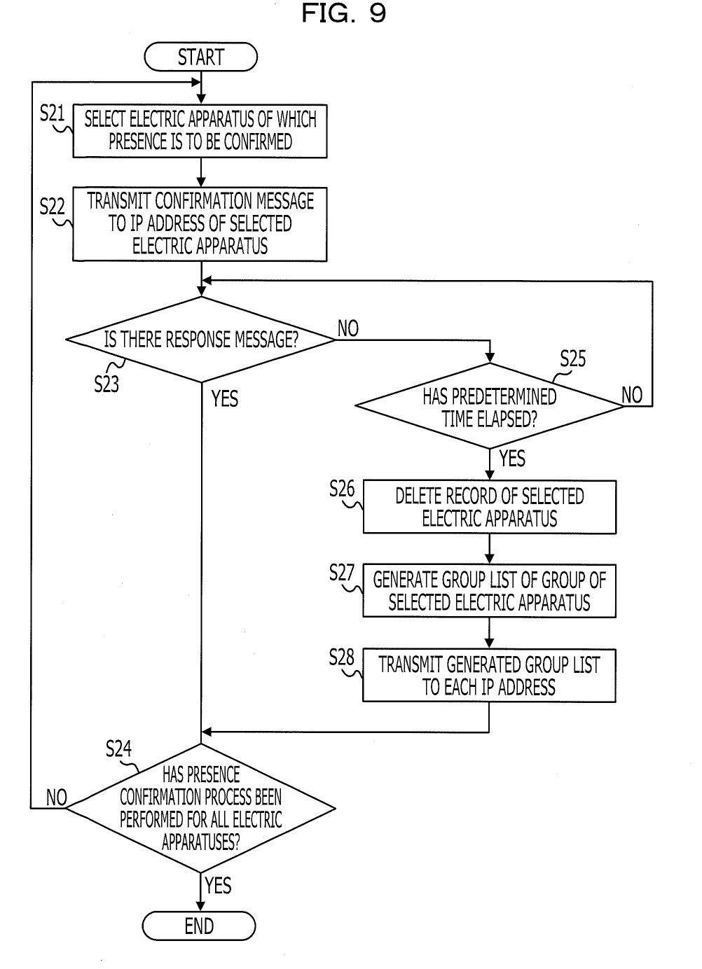

FIG. 9 illustrates a flowchart of an apparatus presence monitoring process that is repeatedly performed by the apparatus monitoring part 140 of the server 100 at regular intervals (e.g., every several minutes) when the communication program is executed in the server 100.

At S21, the apparatus monitoring part 140 selects an electric apparatus 200 of which presence is to be confirmed, by sequentially selecting a record stored in the management table 120.

At S22, the apparatus monitoring part 140 transmits a confirmation message to the IP address in the selected record.

At S23, the apparatus monitoring part 140 determines whether or not a response message to the confirmation message has been received from an electric apparatus 200 to which the IP address in the selected record is allocated, by determining whether or not a response message including the IP address in the selected record has been received. When the response message has been received, the apparatus monitoring part 140 advances the processing to S24 (Yes). On the other hand, when the response message has not been received, the apparatus monitoring part 140 advances the processing to S25 (No).

At S24, the apparatus monitoring part 140 determines whether or not the presence confirmation process has been performed for all electric apparatuses 200 of which communications are managed by the server 100, by determining whether or not the presence confirmation process has been performed for all the records stored in the management table 120. When the presence confirmation process has been performed for all the electric apparatuses 200, the apparatus monitoring part 140 ends the processing (Yes). On the other hand, when the presence confirmation process has not been performed for all the electric apparatuses 200, the apparatus monitoring part 140 advances the processing to S21 (No).

At S25, the apparatus monitoring part 140 determines whether or not a predetermined time (e.g., several seconds) has elapsed from the transmission of the confirmation message to the IP address in the selected record. When the predetermined time has elapsed, the apparatus monitoring part 140 advances the processing to S26 (Yes). On the other hand, when the predetermined time has not elapsed, the apparatus monitoring part 140 advances the processing to S23 (No).

At S26, the apparatus monitoring part 140 extracts the group name from the selected record. In addition, the apparatus monitoring part 140 deletes the selected record from the management table 120.

At S27, the apparatus monitoring part 140 refers to the management table 120 and generates a group list 260 from the IP addresses in all records identified by the extracted group name.

At S28, the apparatus monitoring part 140 transmits the generated group list 260 to all the IP addresses listed in the generated group list 260.

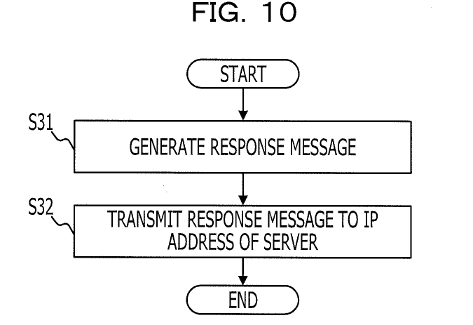

FIG. 10 illustrates a flowchart of a confirmation message response process that is performed by the monitoring response part 240 of each electric apparatus 200 when a confirmation message is received from the server 100.

At S31, the monitoring response part 240 generates a response message to a confirmation message. The response message includes at least the IP address of the own electric apparatus 200.

At S32, the monitoring response part 240 transmits the generated response message to the IP address of the server 100 stored in the storage part 210.

According to the apparatus presence monitoring process and the confirmation message response process, the apparatus monitoring part 140 transmits the confirmation message to each electric apparatus 200. The monitoring response part 240 transmits the response message to the confirmation message. Next, the apparatus monitoring part 140 determines whether or not each electric apparatus 200 is present on the Internet 300 by determining whether or not a response message has been transmitted within the predetermined time. The apparatus monitoring part 140 deletes, from the management table 120, the record of an electric apparatus 200 that is determined not to be present. In addition, the apparatus monitoring part 140 refers to the management table 120 and identifies all records each including the group name in the deleted record. Then, the apparatus monitoring part 140 generates the group list 260 from the IP addresses in all the identified records and transmits the generated group list 260 to all the IP addresses listed in the generated group list 260.

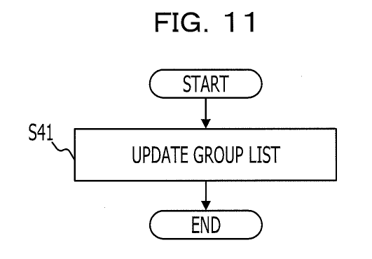

FIG. 11 illustrates a flowchart of a group list reception process that is performed by the list reception part 230 of each electric apparatus 200 when a group list 260 is received from the server 100.

At S41, the list reception part 230 holds a received group list 260 in the own electric apparatus 200 or updates a group list 260 held in the own electric apparatus 200, with the received group list 260.

According to the group list reception process, the list reception part 230 holds the received group list 260 in the own electric apparatus 200, or updates the held group list 260.

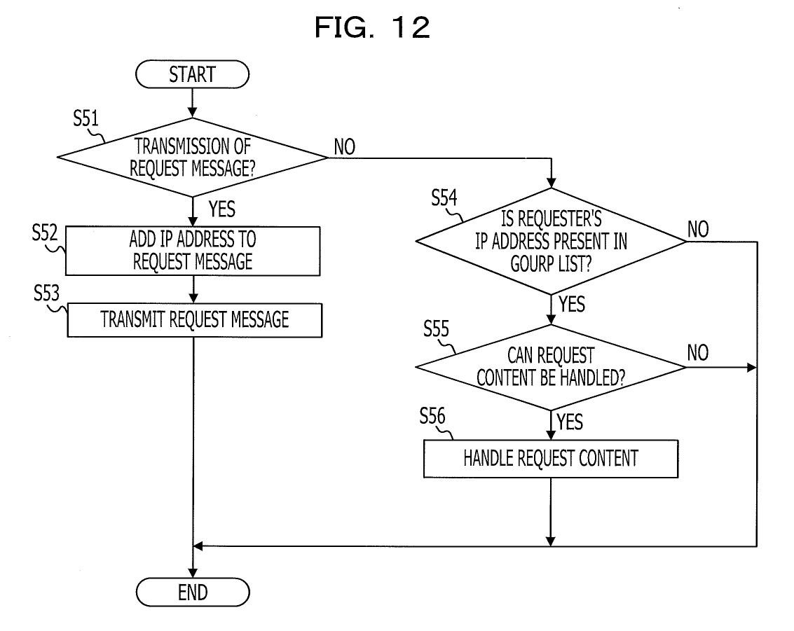

FIG. 12 illustrates a request message process that is performed by the communication part 250 of each electric apparatus 200 when the communication part 250 transmits a request message to another electric apparatus 200 in a group to which the electric apparatus 200 belongs to, or when the communication part 250 receives a request message from another electric apparatus 200. The request message is generated by an application conforming to DLNA (Digital Living Network Alliance) or the like. In addition, the request message includes at least a content requested of the other electric apparatus 200 (e.g., a request content that a television desires to obtain recording data stored in a hard disk recorder, from the hard disk recorder).

At S51, the communication part 250 determines whether or not the timing when the request message process is performed is the timing of transmission of a request message. When it is the timing of transmission of a request message, the communication part 250 advances the processing to S52 (Yes). On the other hand, when it is not the timing of transmission of a request message, the communication part 250 advances the processing to S54 (No).

At S52, the communication part 250 adds the IP address of the own electric apparatus 200 as a requester's IP address to the request message.

At S53, the communication part 250 transmits the request message to all IP addresses other than the IP address of the own electric apparatus 200 among the IP addresses listed in the group list 260.

At S54, the communication part 250 determines whether or not the requester's IP address in the request message is present in the group list 260. When the requester's IP address is present, the communication part 250 advances the processing to S55 (Yes). On the other hand, when the requester's IP address is not present, the communication part 250 ends the processing (No).

At S55, the communication part 250 determines whether or not the request content included in the request message can be handled by the own electric apparatus 200. When the request content can be handled, the communication part 250 advances the processing to S56 (Yes). On the other hand, when the request content cannot be handled, the communication part 250 ends the processing (No). For example, when the request content is to obtain specific recording data, the communication part 250 determines whether or not the recording data is present in the own electric apparatus 200.

At S56, the communication part 250 handles the request content included in the request message.

According to the request message process, the communication part 250 adds the requester's IP address to the request message of the own electric apparatus 200 and transmits the request message to all the IP addresses other than the IP address of the own electric apparatus 200 among the IP addresses listed in the group list 260. In addition, the communication part 250 determines whether or not the request content is to be handled by the own electric apparatus 200 on the basis of the group list 260 and the request content included in the received request message, and handles the request content.

Therefore, when an IP address is allocated to an electric apparatus 200, or when an electric apparatus 200 disappears from the Internet 300, a new group list 260 of a group to which the electric apparatus 200 belongs is generated in the server 100. The generated group list 260 is transmitted to each of electric apparatuses 200 identified by IP addresses listed in the generated group list 260. Then, each electric apparatus 200 communicates with the other electric apparatuses 200 in the group to which the electric apparatus 200, on the basis of the group list 260.

Thus, the electric apparatus 200 to which the IP address is allocated and the other electric apparatuses 200 in the group to which the electric apparatus 200 to which the IP address is allocated belongs can communicate with each other.

In addition, each electric apparatus 200 confirms the requester's IP address in a request message from another electric apparatus 200, and when the request message is a request message transmitted from an electric apparatus 200 in a group different from the group to which the electric apparatus 200 belongs, the electric apparatus 200 does not execute the request content included in the request message. Thus, data held in each electric apparatus 200 can be protected from electric apparatuses 200 in a group different from the group to which the electric apparatus 200 belongs.

It should be noted that an authentication function may be added in the embodiment described above, and when information such as a group name, a MAC address, an IP address, and a group list 260 is transmitted/received between each electric apparatus 200 and the server 100, such information may be transmitted/received after they authenticate each other.

Further, each electric apparatus 200 in the embodiment described above may be an electric apparatus 200 that is connected to the Internet 300 via a gateway. Moreover, an electric apparatus connected directly to the Internet 300 and an electric apparatus 200 connected to the Internet 300 via a gateway may be present in one group.

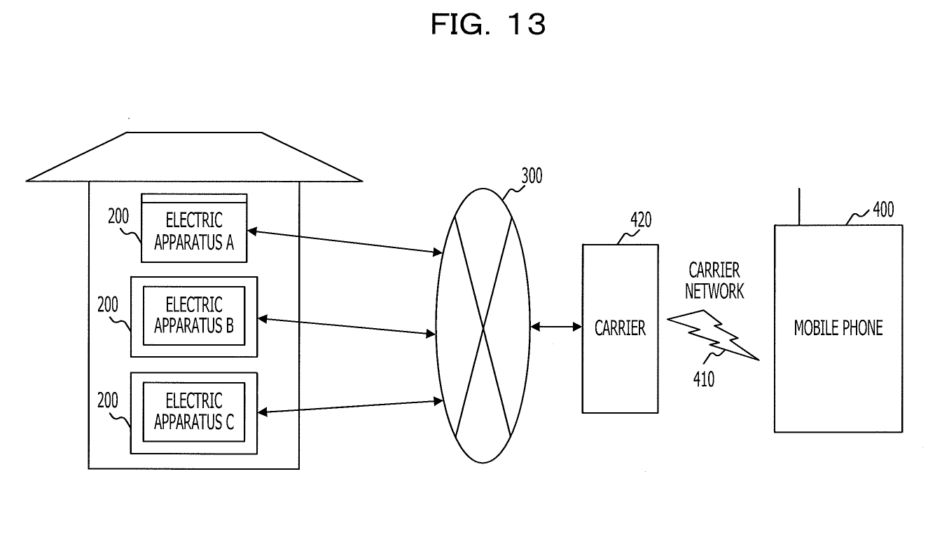

Instead of the server 100 in the embodiment described above, a mobile phone 400 serving as a computer may be used as illustrated in FIG. 13. The mobile phone 400 is connected to the Internet 300 via a carrier network 410 and a carrier 420. The mobile phone 400 implements the same function as that of the server 100 by downloading the communication program from a download site or the like and installing the communication program as an application therein. When the mobile phone 400 is used, information is transmitted/received between the mobile phone 400 and each electric apparatus 200 by e-mail and/or other forms of wire and/or wireless data communication (e.g., text messaging, chat, etc.) to an electric apparatus 200. Thus, an e-mail transmission/reception function is further incorporated into each electric apparatus 200, and the e-mail address of the mobile phone 400 is stored therein instead of the IP address of the server 100. In addition, a function of creating or interpreting an e-mail in accordance with information transmitted/received between each part of the server 100 and each part of the electric apparatus 200, which are described above, is further incorporated in the mobile phone 400 and each electric apparatus 200.

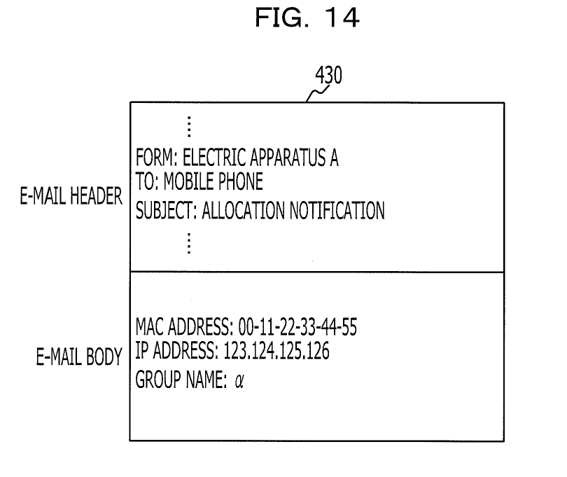

Specifically, in an e-mail, an identifier indicating that the e-mail is information transmitted/received between the mobile phone 400 and an electric apparatus 200 is described at Subject in an e-mail header or the like (e.g., file attachment to an email). In addition, in an e-mail body, a content of information transmitted/received between the mobile phone 400 and the electric apparatus 200 is described. For example, when an IP address is allocated to an electric apparatus A, a content of an e-mail of an allocation notification to be transmitted to the mobile phone 400 has a format as illustrated in FIG. 14. In the example in FIG. 14, in the e-mail header of an e-mail 430, “allocation notification” is described as an identifier at Subject, and the MAC address and the IP address of the electric apparatus A, and the group name of a group to which the electric apparatus A belongs are described in the e-mail body of the e-mail 430.

Further, the function of the server 100 in the embodiment described above may be implemented in each electric apparatus 200 or a communication apparatus such as an access point or a gateway.

According to an aspect of the embodiments of the invention, any combinations of one or more of the described features, functions, operations, and/or benefits can be provided. A combination can be one or a plurality. The embodiments can be implemented as an apparatus (a machine) that includes hardware to execute instructions, for example, computing hardware (i.e., computing apparatus), such as (in a non-limiting example) any computer that can store, retrieve, process and/or output data and/or communicate (network) with other computers. According to an aspect of an embodiment, the described parts, features, functions, operations, and/or benefits can be implemented by and/or use computing hardware and/or software that is executed by hardware. The apparatus (e.g., the electric apparatus 200, server 100) can comprise a controller (CPU) (e.g., a hardware logic circuitry based computer processor that processes or executes instructions, namely software/program), computer readable media, transmission communication interface (network interface), and/or an output device, for example, a display device, and which can be in communication among each other through one or more data communication buses. In addition, an apparatus can include one or more apparatuses in computer network communication with each other or other apparatuses. In addition, a computer processor can include one or more computer processors in one or more apparatuses or any combinations of one or more computer processors and/or apparatuses. An aspect of an embodiment relates to causing one or more apparatuses and/or computer processors to execute the described operations. The results produced can be output to an output device, for example, displayed on the display. An apparatus or device refers to a physical machine, for example, a computer (physical computing hardware or machinery) that implement or execute instructions, for example, by way of software, which is code executed by computing hardware, and/or by way of computing hardware (e.g., in circuitry, etc.), to achieve the functions or operations being described. The functions of embodiments described can be implemented in any type of physical apparatus that can execute instructions or code. More particularly, programming or configuring or causing an apparatus or device, for example, a computer, to execute the described functions of embodiments of the invention creates a new machine where in case of a computer a general purpose computer in effect becomes a special purpose computer once it is programmed or configured or caused to perform particular functions of the embodiments of the invention pursuant to instructions from program software.

A program/software implementing the embodiments may be recorded on a computer-readable media, e.g., a non-transitory or persistent computer-readable medium. Examples of the non-transitory computer-readable media include a magnetic recording apparatus, an optical disk, a magneto-optical disk, and/or volatile and/or non-volatile semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), DVD-ROM, DVD-RAM (DVD-Random Access Memory), BD (Blue-ray Disk), a CD-ROM (Compact Disc-Read Only Memory), and a CD-R (Recordable)/RW. The program/software implementing the embodiments may be transmitted over a transmission communication path, e.g., a wire and/or a wireless network implemented via hardware. An example of communication media via which the program/software may be sent includes, for example, a carrier-wave signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A computer readable, non-transitory medium storing a communication program that manages communications of a plurality of electric apparatuses connectable to the Internet, by a group, the communication program causing a computer to perform a process, the process comprising:
storing a management table storing a record in which an IP address of each electric apparatus and a group identifier identifying a group to which each electric apparatus belongs are associated with each other;
when first information including an IP address and a group identifier is received from an electric apparatus connected to the Internet, updating the management table based upon the first information; and
referring to the updated management table, generating, from records each including the received group identifier in the first information, a group list that lists an IP address used for each electric apparatus belonging to a group identified by the received group identifier to perform intercommunication in the group, and transmitting the group list to each IP address listed in the group list.

2. A computer readable, non-transitory medium according to claim 1, wherein the process further comprises:
when second information including an IP address is received from an electric apparatus that is disconnected from the Internet, deleting a record including the received IP address in the second information from the management table; and
referring to the management table from which the record has been deleted, generating a group list from IP addresses in records each including a group identifier of the deleted record, and transmitting the group list to each IP address listed in the group list.

3. A computer readable, non-transitory medium according to claim 1, wherein the process further comprises:
transmitting a confirmation message to the IP address in each record in the management table at regular intervals; and
deleting, from the management table, a record identified by an IP address of an electric apparatus that has not transmitted a response message to the confirmation message even when a predetermined time has elapsed from transmission of the confirmation message.

4. An electric apparatus comprising:
an information transmission part that when connected to the Internet, transmits first information including an allocated IP address and a group identifier identifying a group, to a computer that manages communication by the group;
a list reception part that receives, from the computer, a group list that lists IP addresses used for performing intercommunication in the group identified by the group identifier in the first information, as a response to the first information; and
a communication part that communicates using the IP addresses listed in the received group list.

5. A communication method for an apparatus for managing communications of a plurality of apparatuses connectable to the Internet, the communication method comprising:
causing one or more apparatuses to execute:
storing a management table storing a record in which an IP address of each apparatus and a group that defines a communication domain to which each apparatus belongs are associated with each other;
when first information including an IP address and a group identifier is received from an apparatus connected to the Internet, updating the management table based upon the first information;
referring to the updated management table, generating, from records each including the received group identifier in the first information, a group list that lists an IP address used for each apparatus belonging to a group identified by the received group identifier; and
transmitting the group list to each IP address listed in the group list.
